(19) United States
(12) Patent Application Publication
(10) Pub. No.: US 2006/0105208 A1
(43) Pub. Date: May 18, 2006

(54) Fuel cell unit

(76) Inventors: Ryoichi Sebori, Fussa-shi (JP); Nobuo Shibuya, Hiratsuka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/274,031

(22) Filed: Nov. 15, 2005

(30) Foreign Application Priority Data
Nov. 16, 2004 (JP) 2004-331978

(51) Int. Cl. H01M 8/04; H01M 2/02

(52) U.S. Cl. 429/14; 429/34

(57) ABSTRACT

A fuel cell unit includes a second flow path, which branches from the first flow path and flows the fuel solution sent out from the mixing tank back to the mixing tank. A sensor detects a concentration of the fuel solution in the second flow path. A controller changes flow of the fuel solution in the second flow path by controlling a mechanism, when the concentration detected by the sensor presents a predetermined state.

### CROSS-REFERENCE TO RELATED APPLICATIONS

This application is based upon and claims the benefit of priority from prior Japanese Patent Application No. 2004-331978, filed Nov. 16, 2004, the entire contents of which are incorporated herein by reference.

### BACKGROUND

1. Field

The present invention relates to a fuel cell unit of, for example, direct methanol type.

2. Description of the Related Art

There are various types of fuel cell. A direct methanol fuel cell (DMFC) is known as suitable for an information processing apparatus. This type of fuel cell employs a dilution circulating system, in which a methanol solution of a low concentration is circulated. Consumption of methanol by power generation is compensated for by supplying high-concentration methanol to the fuel cell. Consumption of water is compensated for by collecting water generated by a chemical reaction in the fuel cell and returning it to the fuel cell. For this purpose, the system has a mixing tank for producing a methanol solution by mixing the high-concentration methanol and water.

To continuously generate power satisfactorily, it is necessary to maintain the methanol concentration in the methanol solution supplied to the DMFC cell to fall within a predetermined range. A concentration sensor is used to detect the methanol concentration. In general, the concentration sensor is arranged in a fuel supply path, through which the methanol solution is supplied from the mixing tank to a DMFC. A type of concentration sensor, which utilizes a sonic speed or refractive index of a pulse passing through the liquid, is commonly employed in this system.

During power generation, the methanol solution in the fuel supply path may contain bubbles, since it is heated to 60° C. or higher. Further, dusts may enter the fuel supply path for some reason. In this case, bubbles may stagnate in the portion where the concentration sensor is mounted. If this state continues, the concentration sensor cannot detect an accurate concentration and power generation will be hindered.

A conventional technique for removing bubbles is disclosed in, for example, Jpn. Pat. Appln. KOKAI Publication No. 2004-95376 (FIG. 5, paragraph 0045, etc.). This publication discloses the following matter: the operation amount of a pump provided in the fuel supply path is changed, if the calculation result of a methanol concentration does not fall within a preset reference range, because there is a possibility that bubbles adhere to the concentration sensor.

The DMFC efficiently generates power when the temperature of the methanol solution is about 60° C. However, the concentration sensor arranged in the fuel supply path, through which the fuel of about 60° C. flows, operates correctly at 40° C. or lower. Therefore, the concentration sensor which directly receives the heat of about 60° C. cannot accurately detect the concentration, and cannot satisfactorily control the system. This problem frequently arises in the type of concentration sensor, which utilizes a sonic speed or refractive index of a pulse passing through the liquid.

Under the circumstances, it is desired to provide a fuel cell unit which detects the concentration of fuel without problems.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external view showing a fuel cell unit according to an embodiment of the present invention;

FIG. 2 is an external view showing a state in which an information processing apparatus is connected to the fuel cell unit;

FIG. 3 is a system diagram mainly showing a configuration of a power generating portion of the fuel cell unit;

FIG. 4 is a system diagram showing the state in which the information processing apparatus is connected to the fuel cell unit;

FIG. 5 is a block diagram showing configurations of the fuel cell unit and the information processing apparatus;

FIG. 6 is a diagram showing transition of states of the fuel cell unit and the information processing apparatus;

FIG. 7 is a diagram showing main control commands issued to the fuel cell unit;

FIG. 8 is a diagram showing main power supply information of the fuel cell unit;

FIG. 9 is a diagram for explaining a configuration of the concentration sensor shown in FIG. 3;

FIG. 10 is a diagram for explaining that normality or abnormality is determined according to the methanol concentration of in a methanol solution;

FIG. 11 is a diagram showing types of the auxiliary mechanism effective to remove bubbles and process operations performed by the respective devices, when the system determines that an abnormal situation occurs; and

FIG. 12 is a flowchart showing an operation of monitoring the methanol concentration in the methanol solution by a fuel cell control section.

### DETAILED DESCRIPTION

Embodiments of the present invention will be described below with reference to the drawings.

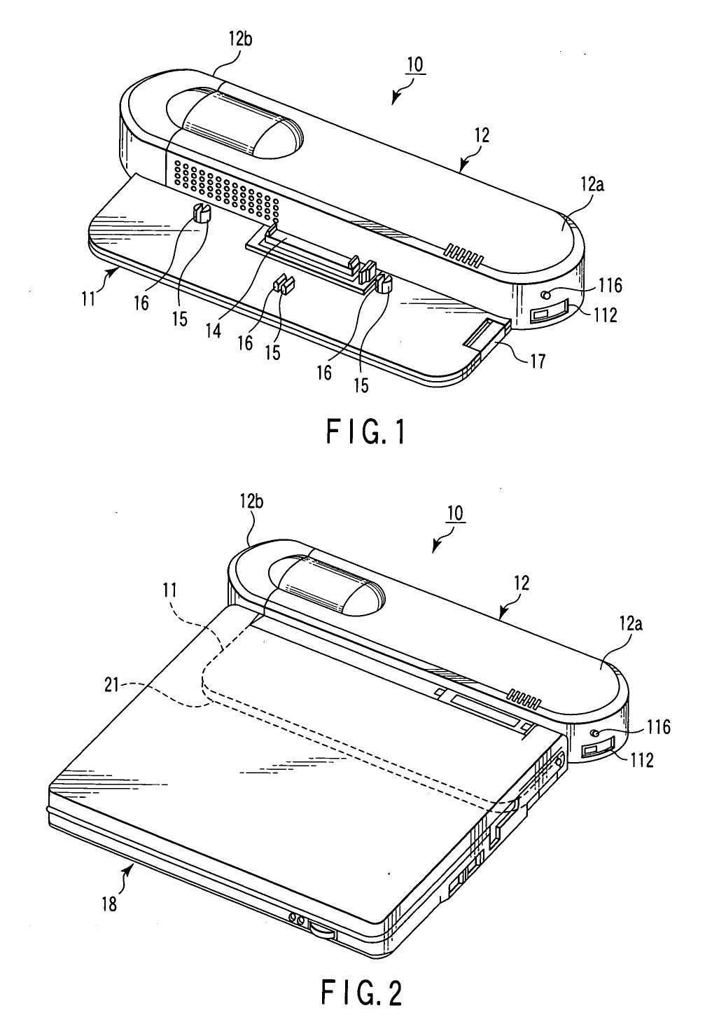

FIG. 1 is an external view showing a fuel cell unit according to an embodiment of the present invention. As shown in FIG. 1, the fuel cell unit 10 includes a mount portion 11 and a fuel cell unit body 12. On the mount portion 11, a rear portion of an information processing apparatus, such as a notebook computer, is to be mounted. The fuel cell unit body 12 incorporates a DMFC stack, which generates power by an electrochemical reaction, and auxiliary mechanism (a pump, a valve, etc.) to inject and circulate methanol (fuel) and air in the DMFC stack.

The fuel cell unit body 12 has a unit case 12a and a cover 12b. The unit case 12a incorporates a detachable fuel cartridge (not shown) in, for example, a left side end portion. The cover 12b is removable so that the fuel cartridge can be exchanged for another one.

An information processing apparatus is mounted on the mount portion 11. A docking connector 14, which serves as a connecting portion to connect with the information processing apparatus, is provided on the upper surface of the mount portion 11. On the other hand, a docking connector 21 (represented by broken lines), which serves as a connecting portion to connect with the fuel cell unit 10, is provided on, for example, a rear portion of the bottom surface of the information processing apparatus. The docking connector 21 is mechanically and electrically connected to the docking connector 14 of the fuel cell unit 10. Three positioning projections 15 and three hooks 16 are formed on the mount portion 11. They are inserted in three corresponding holes in the rear portion of the bottom surface of the information processing apparatus.

To remove the information processing apparatus from the fuel cell unit 10, an eject button 17 of the fuel cell unit 10 shown in FIG. 2 is pushed. As a result, a lock mechanism (not shown) is released and the information processing apparatus can be easily removed from the fuel cell unit 10.

A power generation setting switch 112 and a fuel cell operation switch 116 are provided on, for example, a right side surface of the fuel cell unit body 12.

The power generation setting switch 112 is formed of, for example, a slide switch, which allows the user to preset permission or prohibition of power generation by the fuel cell unit 10.

The fuel cell operation switch 116 is used, for example, in a case where the information processing apparatus 18 is operated by the power generated by the fuel cell unit 10, and the information processing apparatus 18 is to continue operating, whereas power generation of the fuel cell unit 10 is stopped. In this case, the information processing apparatus 18 continues operating by using power of a secondary battery incorporated therein. The fuel cell operation switch 116 is formed of, for example, a push switch.

FIG. 2 is an external view showing a state in which the information processing apparatus 18 (for example, the notebook computer) is mounted on and connected to the mount portion 11 of the fuel cell unit 10.

The shape and size of the fuel cell unit 10 and the shape and position of the docking connector 14, shown in FIGS. 1 and 2, are mere examples, and may be of variously modified.

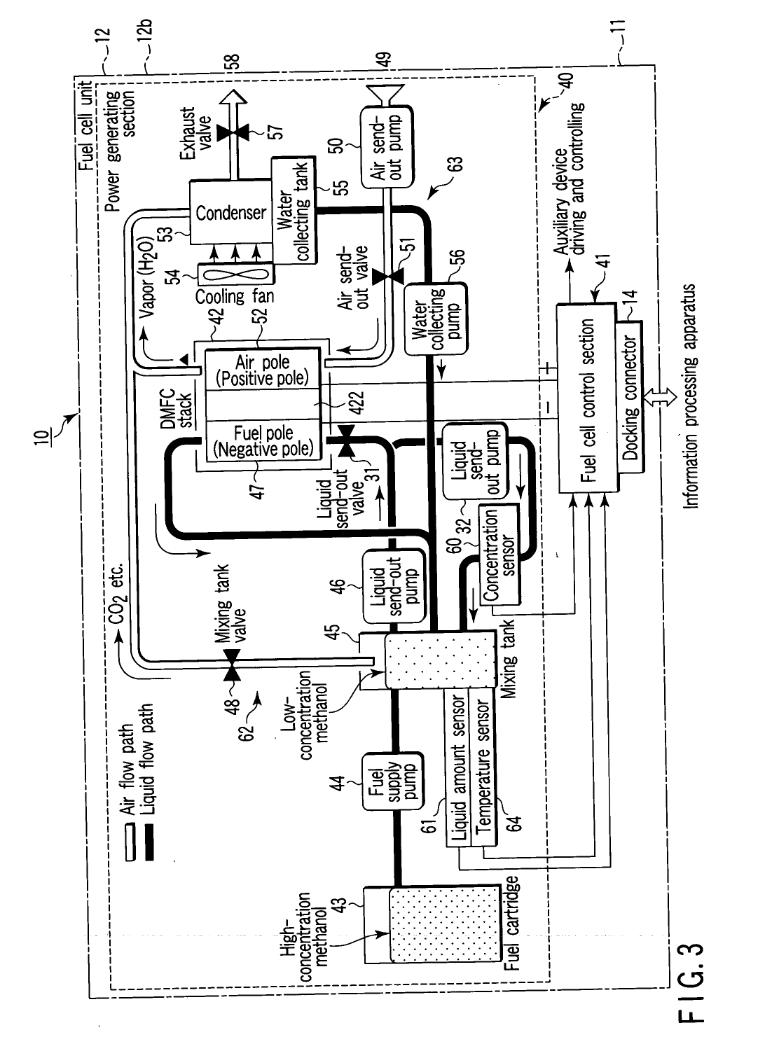

FIG. 3 is a system diagram of the fuel cell unit 10, showing in particular detailed systems of the DMFC stack and the auxiliary mechanism provided around it.

The fuel cell unit 10 includes a power generating section 40, and a fuel cell control section 41, which is a control section of the fuel cell unit 10. The fuel cell control section 41 not only controls the power generating section 40 but also functions as a communication control section to perform communication with the information processing apparatus 18.

The power generating section 40 includes the DMFC stack 42, which is a center of power generation. It also includes a fuel cartridge 43 containing methanol, i.e., fuel. Methanol of a high concentration is sealed within the fuel cartridge 43. The fuel cartridge 43 is removably attached to the power generating section 40, so that it can be easily exchanged with a new one when the fuel is consumed.

Generally, in a direct methanol type-fuel cell, a crossover phenomenon must be reduced to improve the power generation efficiency. For this purpose, it is effective to dilute high-concentration methanol, and inject the obtained low-concentration methanol into a fuel pole 47. The fuel cell unit 10 employs a dilution circulating system 62; that is, auxiliary mechanism 63 necessary to realize the dilution circulating system 62 is provided in the power generating section 40.

The auxiliary mechanism 63 is provided in a liquid flow path and an air flow path.

In the liquid flow path, an output portion of the fuel cell cartridge 43 is connected to a fuel supply pump 44 and an output portion of the fuel supply pump 44 is connected to a mixing tank 45. An output portion of the mixing tank 45 is connected to a liquid send-out pump 46, and an output portion of the liquid send-out pump 46 is connected to the fuel pole 47 of the DMFC stack 42 via a liquid send-out valve 31. Further, an output portion of the fuel pole 47 is connected to the mixing tank 45. This liquid flow path for flowing the liquid back to the mixing tank 45 by means of the power of the liquid send-out pump 46 is called “a first liquid flow path”. The liquid send-out pump 46 may be provided on the output side of the fuel pole 47, instead of the input side of the fuel pole 47. The liquid send-out valve 31 is not essentially required.

An output portion of a water collecting tank 55 is connected to a water collecting pump 56. An output portion of the water collecting pump 56 is connected to the mixing tank 45.

In the first liquid flow path described above, a branch is formed between the liquid send-out pump 46 and the fuel pole 47. Another flow path (a pipe or the like), which causes the methanol solution to flow back to the mixing tank 45, extends from the branch. This flow path is called “a second liquid flow path”. The second liquid flow path is a path dedicated to detection of the methanol concentration in the methanol solution. A liquid send-out pump 32 is provided in the second liquid flow path. An output portion of the liquid send-out pump 32 is connected to the mixing tank 45 via a concentration sensor 60. The liquid send-out pump 32 is not indispensable.

The concentration sensor 60 is provided in a portion of the flow path at which the methanol solution flowing from the first liquid flow path to the second liquid flow path (at 60° C. or higher) is cooled to, for example, 40° C. or lower. Thus, the concentration sensor 60 is protected against an adverse influence by the heat.

The concentration sensor 60 requires a very small amount of methanol solution (a negligible amount relative to all methanol solution used in the power generating section 40) to detect the concentration. The inner diameter of the second liquid flow path is much smaller than that of the first liquid flow path; that is, the amount of methanol solution flowing in the second liquid flow path is very small. Thus, the fuel supply to the DMFC stack 42 is not adversely influenced.

On the other hand, in the air flow path, an air send-out pump 50 is connected to an air pole 52 of the DMFC stack 42 via an air send-out valve 51. An output portion of the air pole 52 is connected to a condenser 53. The mixing tank 45 is also connected to the condenser 53 via a mixing tank valve 48. The condenser 53 is connected to an exhaust port 58 via an exhaust valve 57. The condenser 53 has a fin, which effectively condenses vapor. A cooling fan 54 is arranged near the condenser 53.

Power generation mechanism of the power generating section 40 of the fuel cell unit 10 will now be described with reference to the flow of the fuel and air (oxygen).

First, the high-concentration methanol in the fuel cartridge flows into the mixing tank 45 by means of the fuel supply pump 44. In the mixing tank 45, the high-concentration methanol is mixed with the collected water and the low-concentration methanol (which has been left after the power generating reaction) supplied form the fuel pole 47. Thus, the high-concentration methanol is diluted into a low-concentration methanol. The low-concentration methanol is kept to a concentration (for example, 3 to 6%), which provides a high power generating efficiency. The concentration is controlled by the fuel cell control section 41, which controls the amount of the high-concentration methanol supplied to the mixing tank 45 via the fuel supply pump 44, based on, for example, the detection results of the concentration sensor 60. Alternatively, the concentration may be controlled by the water collecting pump 56, which controls the amount of water flowing back to the mixing tank 45.

The mixing tank 45 is provided with a liquid amount sensor 61, which detects the amount of the methanol solution in the mixing tank 45, and a temperature sensor 64, which detects the temperature.

The detection results are supplied to the fuel cell control section 41 and used to control the power generating section 40 or the like.

The methanol solution diluted in the mixing tank 45 is pressurized by the liquid send-out pump 46, and injected into the fuel pole (negative pole) 47 of the DMFC stack 42. In the fuel pole 47, methanol is oxidized, with the result that electrons are generated. Hydrogen ions (H⁺) generated by the oxidization pass through a solid polymer electrolytic film 422 in the DMFC stack 42 and reach the air pole (positive pole) 52.

Carbon dioxide generated by the oxidization in the fuel pole 47 flows back to the mixing tank 45 together with the methanol solution that has not been used in the oxidization. Carbon dioxide evaporates in the mixing tank 45, flows to the condenser 53 via the mixing tank valve 48, and finally discharges out through the exhaust port 58 via the exhaust valve 57.

On the other hand, air (oxygen) is taken in the system through an intake port 49, pressurized by the air send-out pump 50, and injected into the air pole (positive pole 52) via the air send-out valve 51. In the air pole 52, the reduction of oxygen (O₂) progresses, so that water (H₂O) as vapor is generated from oxygen (O₂), electrons (e⁻) supplied from an external load and hydrogen ions (H⁺) supplied from the fuel pole 47. The vapor is discharged out of the air pole 52, and enters the condenser 53. In the condenser 53, the vapor is cooled by the cooling fan 54 and condensed into water (liquid), which is temporarily stored in the water collecting tank 55. The collected water flows back to the mixing tank 45 by means of the water collecting pump 56. Thus, the dilution circulating system 62 to dilute the high-concentration methanol is constructed.

As can be understood from the power generating mechanism of the fuel cell unit 10 utilizing the dilution circulating system 62, the auxiliary mechanism 63, such as the pumps 44, 46, 50 and 56, the valves 48, 51 and 57 or the cooling fan 54, is driven in order to obtain power from the DMFC stack, i.e., to start power generation. As a result, the methanol solution and air (oxygen) are injected into the DMFC stack 42, and the electrochemical reaction progresses therein, thereby generating power. To stop power generation, drive of the auxiliary mechanism 63 is stopped.

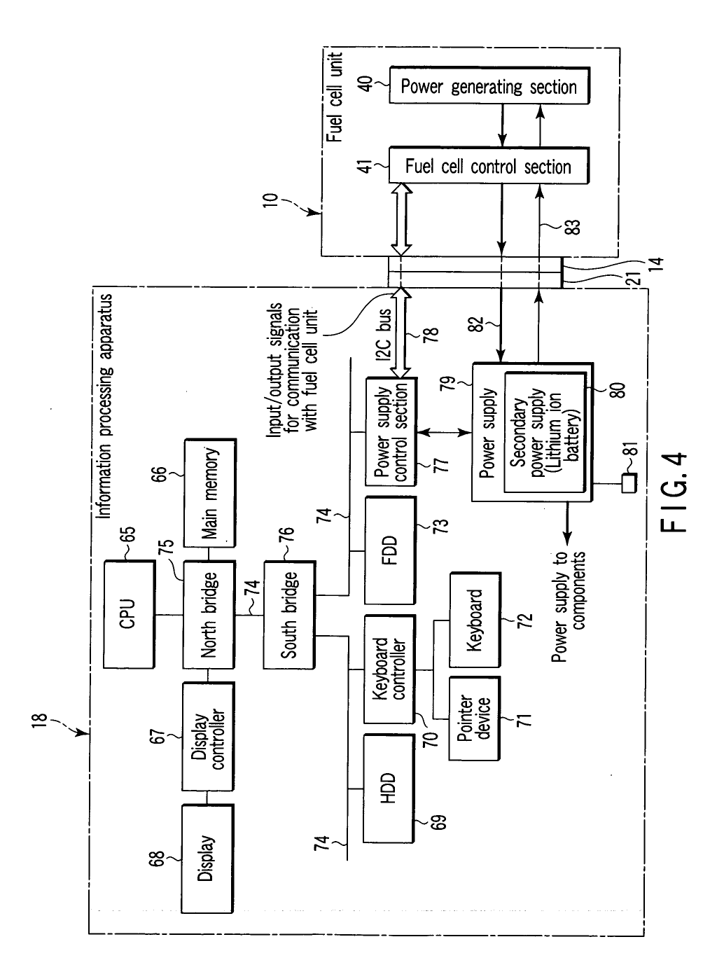

FIG. 4 shows a system configuration of the information processing apparatus 18, to which the fuel cell unit 10 according to the present invention is connected.

The information processing apparatus 18 includes a CPU 65, a main memory 66, a display controller 67, a display 68, a hard disk drive (HDD) 69, a keyboard controller 70, a pointer device 71, a keyboard 72, an FDD 73, a bus 74 which transmits signals between these components, and devices called a north bridge 75 and a south bridge 76 to convert signals transmitted through the bus 74. The information processing apparatus 18 includes a power supply 79, which contains a secondary power supply 80, such as a lithium ion battery. The power supply 79 is controlled by a control section 77 (hereinafter referred to as the power supply control section 77).

A control system interface and a power supply system interface are provided as an electric interface between the fuel cell unit 10 and the information processing apparatus 18. The control system interface is provided to perform communications between the power supply control section 77 of the information processing apparatus 18 and the control section 41 of the fuel cell unit 10. Communications between the information processing apparatus 18 and the fuel cell unit 10 via the control system interface are performed through a serial bus, such as an I2C bus 78.

The power supply system interface is provided to supply power between the fuel cell unit 10 and the information processing apparatus 18. For example, the power generated by the DMFC stack 42 of the power generating section 40 is supplied to the information processing apparatus 18 via the control section 41 (hereinafter referred to as the fuel cell control section 41) and the docking connectors 14 and 21. Further, the power supply system interface includes power supply 83 from the power supply 79 of the information processing apparatus 18 to the auxiliary mechanism 63 etc. of the fuel cell unit 10.

Direct current power, which has been AC/DC converted via an AC adapter connector 81, is supplied to the power supply 79 of the information processing apparatus 18. The information processing apparatus 18 can be operated and the secondary power supply (lithium ion battery) 80 can be charged by this power supply.

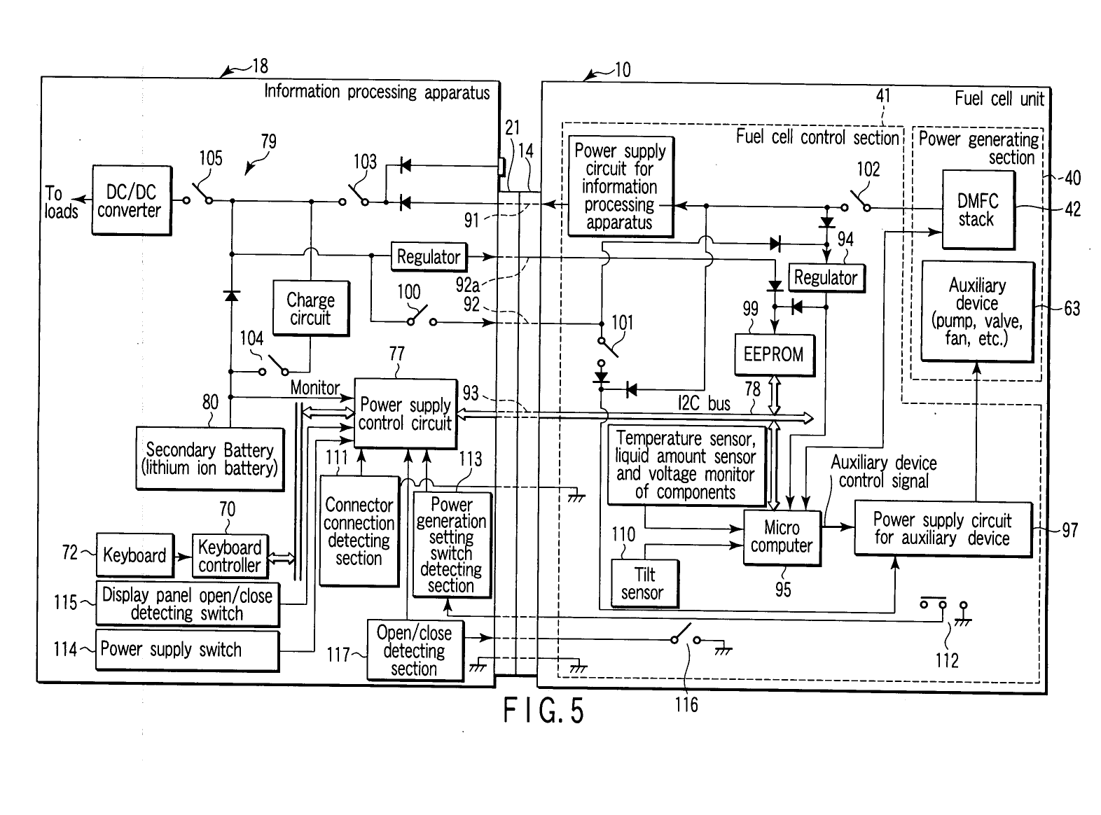

FIG. 5 is a block diagram showing interconnection between the fuel cell control section 41 of the furl cell unit 10 and the power supply 79 of the information processing apparatus 18.

The fuel cell unit 10 and the information processing apparatus 18 are mechanically and electrically connected to each other via the docking connectors 14 and 21. The docking connectors 14 and 20 have a first power supply terminal (output power supply terminal) 91 to supply power generated by the DMFC stack 42 of the fuel cell unit 10 to the information processing apparatus 18, and a second power supply terminal (input power supply terminal for the auxiliary mechanism) 92 to supply power from the information processing apparatus 18 to a microcomputer 95 of the fuel cell unit 10 via a regulator 94 and also to supply power to the power supply circuit 97 for the auxiliary mechanism 63 via a switch 101. They also have a third power supply terminal 92a to supply power from the information processing apparatus 18 to an EEPROM 99.

Further, the docking connectors 14 and 21 have a communication input/output terminal 93 to perform communications between the power supply control section 77 of the information processing apparatus 18 and the microcomputer 95 of the fuel cell unit 10 or the programmable non-volatile memory (EEPROM) 99.

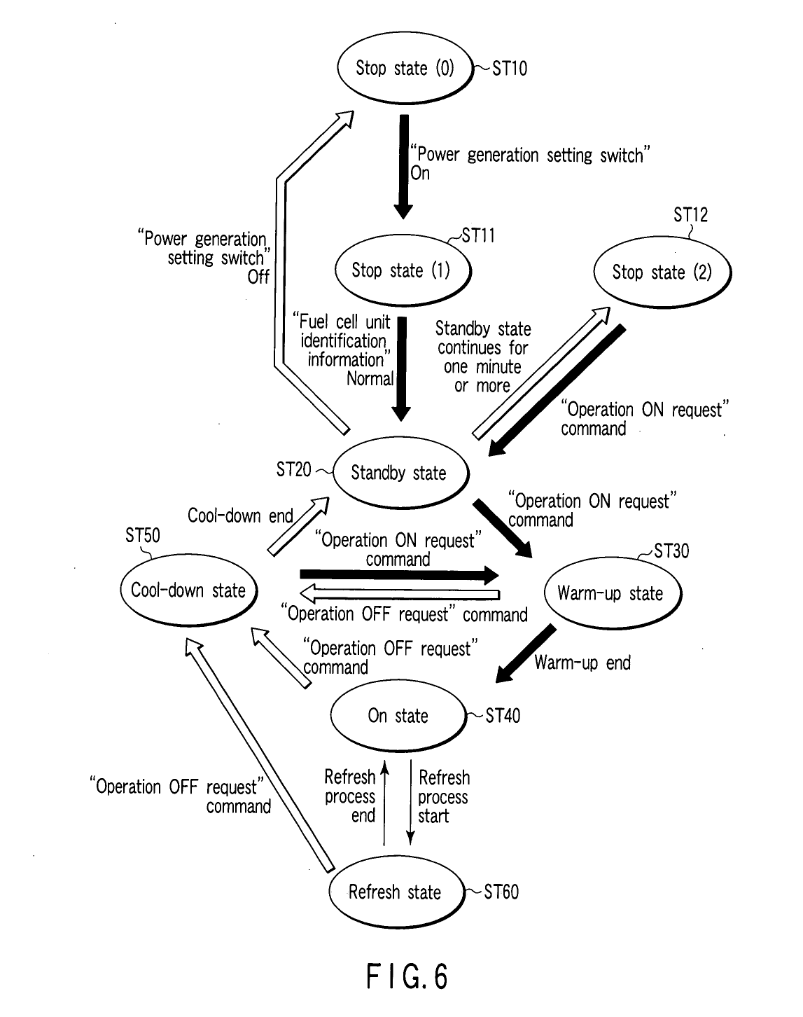

A flow of a basic process for supplying power from the DMFC stack 42 in the fuel cell unit 10 to the information processing apparatus 18 will now be described with reference to the interconnection diagram of FIG. 5 and a diagram showing transition of states of the fuel cell unit 10 of FIG. 6.

It is assumed that the secondary battery (lithium ion battery) 80 of the information processing apparatus is charged with a predetermined power and all switches shown in FIG. 5 are open.

First, the information processing apparatus 18 recognizes that the information processing apparatus 18 and the fuel cell unit 10 are mechanically and electrically connected according to a signal output from a connector connection detecting section 111. This recognition is performed by means of detecting, for example, that the connector connection detecting section 111 is grounded in the fuel cell unit 10 by the connection of the docking connectors 14 and 21 based on the signal input to the connector connection detecting section 111.

The power supply control section 77 of the information processing apparatus 18 recognizes whether the power generation setting switch 112 of the fuel cell unit 10 is set to power generation permission position or power generation prohibition position. For example, a power generation setting switch detecting section 113 detects whether the power generation setting switch 112 is grounded or open. If the power generation setting switch 112 is detected to be open, the power supply control section 77 recognizes that the switch 112 is set to the power generation prohibition position.

The state where the power generation setting switch 12 is set to the power generation prohibition position corresponds to a “stop state (0)” ST10 in the state transition diagram of FIG. 6.

When the information processing apparatus 18 and the fuel cell unit 10 are mechanically connected by the docking connectors 14 and 21, power is supplied from the information processing apparatus 18 to the non-volatile memory (EEPROM) 99, i.e., a memory portion of the fuel cell control section 41, through the third power supply terminal 92a. The EEPROM 99 prestores identification information of the fuel cell unit 10 etc. The identification information may include in advance, for example, a part code, a manufacturing serial number or a nominal output of the fuel cell unit. The EEPROM 99 is connected to a serial bus, such as an I2C bus 78, so that the data stored in the EEPROM 99 can be read out as far as the power is supplied to the EEPROM 99. In the structure shown in FIG. 5, the power supply control section 77 can read information from the EEPROM 99 via the communication input/output terminal 93.

In this state, the fuel cell unit 10 does not generate power, and power has not been supplied to any components other than the EEPROM 99.

If the user changes the setting of the power generation setting switch 112 to power generation permission position (referring to FIG. 5, the power generation setting switch 112 is grounded), the power supply control section 77 in the information processing apparatus 18 can read identification information from the EEPROM 99 in the fuel cell unit 10. This state corresponds to a “stop state (1)” ST11 in FIG. 6.

In other words, unless the user changes the setting of the power generation setting switch 112 to the power generation permission position, that is, as long as the power generation setting switch 112 is set to the power generation prohibition position, the “stop state (0)” ST10 is maintained. Thus, the power generation in the fuel cell unit 10 can be prohibited.

It is preferable that the power generation setting switch be a slide switch or the like, which keeps either the open or closed state of the switch.

Reading of identification information by the power supply control section 77 is performed by means of reading the identification information of the fuel cell unit 10 from the EEPROM 99 in the fuel cell unit 10 via the serial bus, such as the I2C bus 78.

If it is determined that the fuel cell unit 10 connected to the information processing apparatus 18 is adapted for the information processing apparatus 18 based on the identification information read by the power supply control section 77, the “stop state (1)” ST11 in FIG. 6 transitions to a “standby state” ST20.

More specifically, the power supply control section 77 in the information processing apparatus 18 closes the switch 100 in the information processing apparatus 18, thereby supplying the power from the secondary battery 80 to the fuel cell unit 10 via the first power supply terminal 92. The power is supplied to the microcomputer 95 via the regulator 94.

In the “standby state” ST20, the switch 101 in the fuel cell unit 10 is open and no power is supplied to the power supply circuit 97 for the auxiliary mechanism 63. Therefore, in this state, the auxiliary mechanism 63 does not operate.

However, the microcomputer 95 starts operating, and is ready to receive various control commands from the power supply control section 77 in the information processing apparatus 18 through the I2C bus 78. The microcomputer 95 is also ready to send power supply information of the fuel cell unit 10 to the information processing apparatus 18 through the I2C bus.

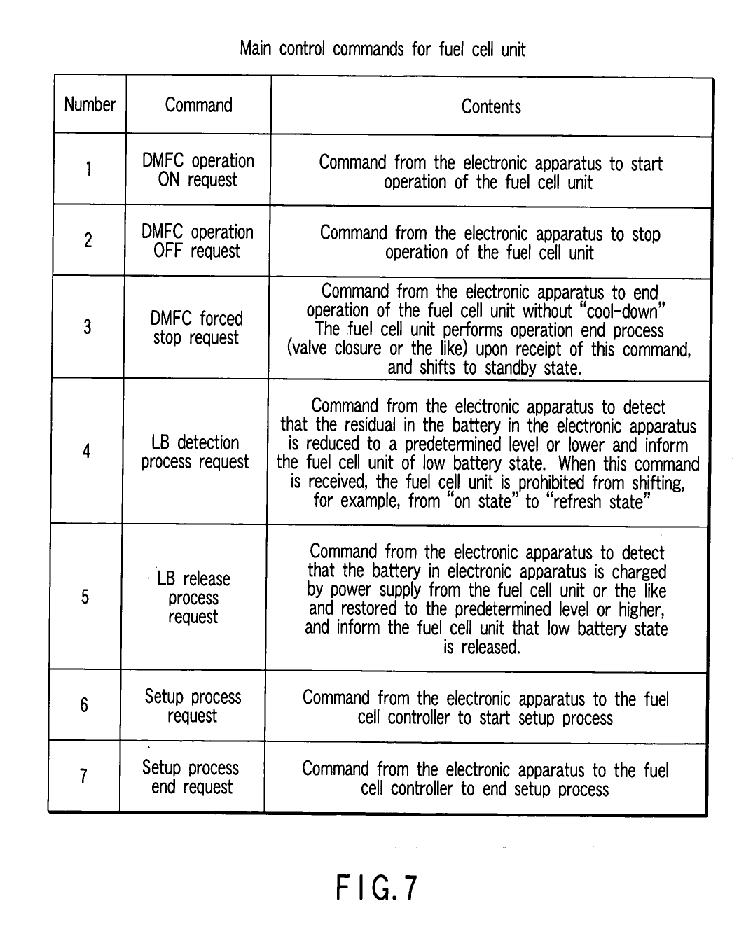

FIG. 7 shows examples of control commands sent from the power supply control section 77 in the information processing apparatus 18 to the microcomputer 95 in the fuel cell control section 41.

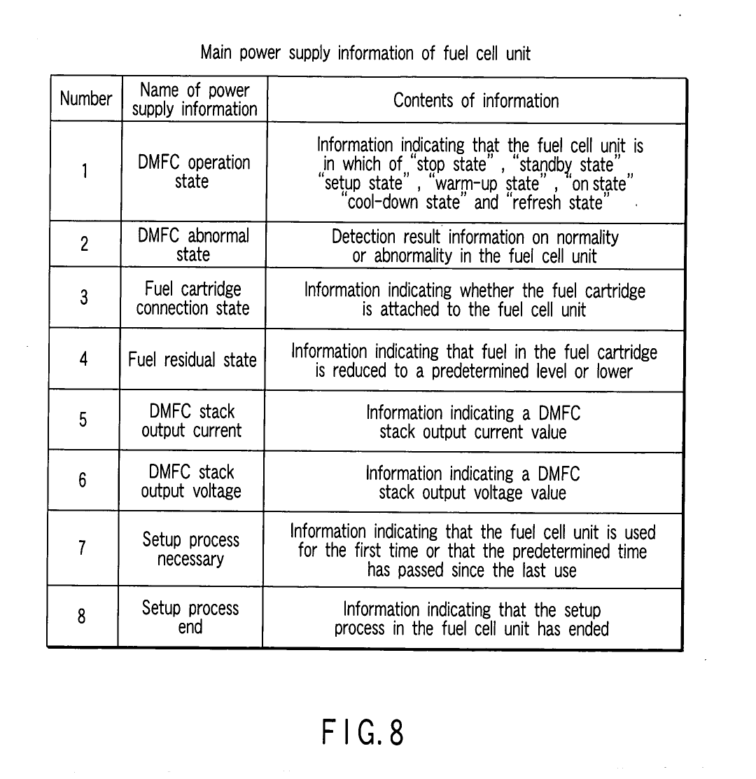

FIG. 8 shows examples of power supply information sent from the microcomputer 95 in the fuel cell control section 41 to the power supply control section 77 in the information processing apparatus 18.

The power supply control section 77 in the information processing apparatus 18 reads “DMFC operation state” (Number 1 in FIG. 8) from the power supply information shown in FIG. 8, thereby recognizing that the fuel cell unit 10 is in the “standby state” ST20.

In the “standby state” ST20, when the power supply control section 77 sends a “DMFC operation ON request” command (power generation start command) of the control commands shown in FIG. 7 to the fuel cell control section 41, the fuel cell control section 41 shifts the state of the fuel cell unit 10 to a “warm-up state” ST30 upon receipt of the command.

More specifically, the switch 101 in the fuel cell control section 41 is closed under the control of the microcomputer 95, thereby supplying power from the information processing apparatus 18 to the power supply circuit 97 for the auxiliary mechanism 63. Simultaneously, the auxiliary mechanism 63 in the power generating section 40, such as the pumps 44, 46, 50 and 56, the valves 48, 51 and 57 and the cooling fan 54 shown in FIG. 4, is driven in accordance with the auxiliary mechanism control signal sent from the microcomputer 95. Further, the microcomputer 95 closes a switch 102 in the fuel cell control section 41.

As a result, the methanol solution and air are injected into the DMFC stack 42 in the power generating section 40, so that power generation starts. Supply of power generated by the DMFC stack 42 to the information processing apparatus 18 also starts. However, since the generated power does not instantaneously reach the nominal output, the state until the power reaches the nominal output is called the “warm-up state” ST30.

When the microcomputer 95 in the fuel cell control section 41 determines that the output of the DMFC stack 42 reaches the nominal output by, for example, monitoring the output voltage of the DMFC stack 42 and the temperature of the DMFC stack 62, it opens the switch 101 in the fuel cell unit 10, so that the source of the power supplied to the auxiliary mechanism 63 is switched from the information processing apparatus 18 to the DMFC stack 42. This state corresponds to an “on state” ST40.

The above description is a summary of the process from the “stop state” ST10 to the “on state” ST40.

The concentration sensor 60 will now be described with reference to FIGS. 3 and 9 to 12.

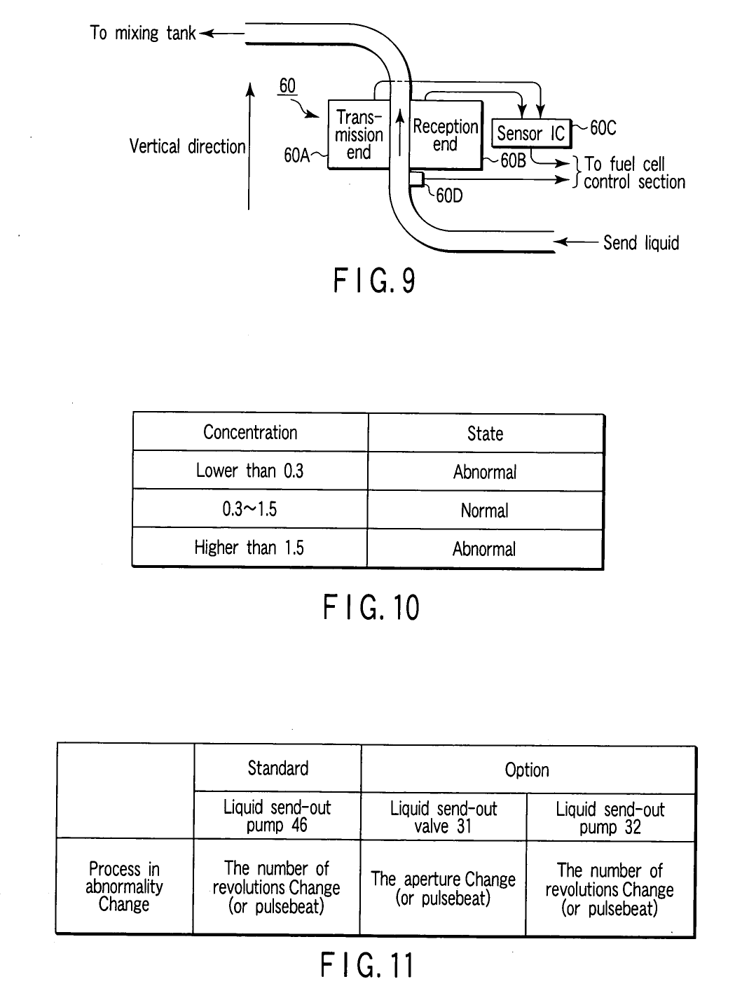

FIG. 9 is a diagram for explaining a configuration of the concentration sensor 60.

The concentration sensor 60 is provided in the second liquid flow path described above (i.e., the flow path which branches from the first liquid flow path and through which the methanol solution sent out from the liquid send-out pump 46 flows back to the mixing tank 45). The concentration sensor 60 is attached to the portion of the second liquid flow path at which the methanol flows against the gravity, i.e., upward (for example, in the vertical direction). In such a portion, the bubbles, whose specific gravity is smaller than the methanol solution, easily get out from the solution and do not probably stagnate in the flow path. Even if the bubbles stagnate, they may easily get out by changing the flow of the methanol solution by the control as will be described later.

The concentration sensor 60 is provided in a portion of the flow path at which the methanol solution flowing from the first liquid flow path to the second liquid flow path (at 60° C. or higher) is cooled to, for example, 40° C. or lower. Thus, the concentration sensor 60 is protected against an adverse influence by the heat.

A type of sensor, called a sonic speed sensor, is used as the concentration sensor 60 in this embodiment. However, the concentration sensor is not limited to the sonic speed sensor, but may be any other type of sensor, which can finally measure the methanol concentration. In the case of using the sonic speed sensor, the concentration sensor 60 has, for example, a transmission end 60A, a reception end 60B, a sensor IC 60C and a temperature sensor (or a thermistor) 60D. The afore-mentioned portion of the second liquid flow path is situated between the transmission end 60A and the reception end 60B.

The transmission end 60A periodically transmits a predetermined pulse to the reception end 60B. The reception end 60B receives the pulse transmitted from the transmission end 60A. The sensor IC 60C detects the sonic speed of the pulse transmitted through the methanol solution at the aforementioned portion of the second liquid flow path based on the difference between the timing when the pulse is transmitted from the transmission end 60A and the timing when the pulse is received by the reception end 60B. There is a tendency that the higher the methanol concentration, the lower the sonic speed. The result of detection by the sensor IC 60C is notified to the fuel cell control section 41. The temperature sensor 60D detects the temperature of the methanol solution flowing through the aforementioned portion of the flow path. It is known that the methanol concentration in the methanol solution varies depending on the temperature of the methanol solution. Therefore, the temperature detected by the temperature sensor 60D is also used to measure the methanol concentration. The result of detection by the temperature sensor 60D is notified to the fuel cell control section 41.

The fuel cell control section 41 obtains the methanol concentration in the methanol solution based on the results of the detection by the sensor IC 60C and the temperature sensor 60D. More specifically, the fuel cell control section 41 obtains the methanol concentration from the measured sonic speed based on the correlation between the methanol concentration and the sonic speed. Further, the value of the methanol concentration is corrected in accordance with the temperature measured by the temperature sensor 60D. The concentration sensor may be configured such that the final calculation of the methanol concentration is executed inside the sensor IC 60C.

The fuel cell control section 41 determines whether the methanol concentration is “abnormal” or “normal” depending on whether the methanol concentration obtained in the above manner falls outside a predetermined range of the concentration (or is constant) for a certain period of time. For example, as shown in FIG. 10, if the methanol concentration falls outside the range of 0.3 to 1.5 mol/l for a certain period of time (or the methanol concentration is constant for a certain period of time), the fuel cell control section 41 determines that abnormality, such as stagnation of bubbles or dust, may occur in the portion of the flow path where the concentration sensor 60 is attached. On the other hand, if the methanol concentration falls within the range of 0.3 to 1.5 mol/l, the fuel cell control section 41 determines that the state of the flow path is normal.

When the fuel cell control section 41 determines that “abnormality” occurs, it changes the flow of the methanol solution in the second liquid flow path by controlling the auxiliary mechanism 63. As a result, the flow of the methanol solution in the portion of the flow path to which the concentration sensor 60 is attached also changes, and it is expected that the stagnated bubbles are oscillated and are removed from that portion of the flow path.

FIG. 11 is a diagram showing types of auxiliary mechanism 63 effective to remove bubbles and process operations performed by the respective devices, when the system determines that an abnormal situation occurs.

The liquid send-out pump 46 is provided as standard, because this is necessary for the auxiliary mechanism 63 in order to supply the methanol solution to the fuel pole 47 of the DMFC stack 42. The flow of the methanol solution in the portion of the flow path, to which the concentration sensor 60 is attached, is varied by changing the number of revolutions of the liquid send-out pump 46 or periodically increasing and decreasing the number of revolutions (i.e., changing or pulsing the flow of the methanol solution in the flow path, to which the concentration sensor 60 is attached). This change of the flow of the methanol solution is effective to remove the bubbles or the like which stagnate in that portion of the flow path.

The liquid send-out valve 31 is optionally provided, not necessarily provided. If the liquid send-out valve 31 is provided, the flow of the methanol solution in the portion of the flow path, to which the concentration sensor 60 is attached, is varied by changing or periodically increasing and decreasing the aperture of the valve (i.e., changing or pulsing the flow of the methanol solution). This change of the flow of the methanol solution is effective to remove the bubbles or the like which stagnate in that portion of the flow path.

The liquid send-out pump 32 is optionally provided, not necessarily provided. If the liquid send-out pump 32 is provided, the flow of the methanol solution in the portion of the flow path, to which the concentration sensor 60 is attached, is varied by changing the number of revolutions of the liquid send-out pump 32 or periodically increasing and decreasing the number of revolutions (i.e., changing or pulsing the flow of the methanol solution). This change of the flow of the methanol solution is effective to remove the bubbles or the like which stagnate in that portion of the flow path.

It is possible to remove the bubbles or the like by changing at least one of the number of revolutions of the liquid send-out pump 46 so as to change or pulse the flow of the methanol solution, the aperture of the liquid send-out valve 31 and the number of revolutions of the liquid send-out pump 32. However, the number of revolutions of the liquid send-out pump 46 may be varied in cooperation with varying the aperture of the liquid send-out valve 31. Alternatively, the number of revolutions of the liquid send-out pump 46 may be varied in cooperation with varying the number of revolutions of the liquid send-out pump 32. In this case, the flow of the methanol solution in the portion of the flow path to which the concentration sensor 60 is attached is changed more reliably. As a result, the bubbles or the like which stagnate in that portion can be removed more effectively.

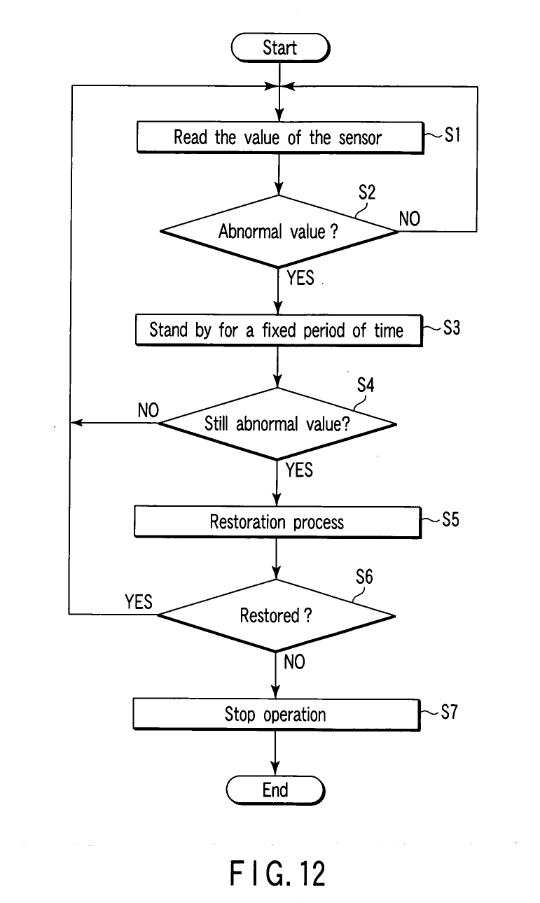

An operation of monitoring the methanol concentration in the methanol solution by the fuel cell control section will be described with reference to FIG. 12.

It is assumed that the DMFC stack 42 is under the normal power generating operation, i.e., the “on state” ST40 (see FIG. 6), in the fuel cell unit 10.

The fuel cell control section 41 reads the detection result of the concentration sensor 60, thereby obtaining the methanol concentration of the methanol solution (step S1). Then, the fuel cell control section 41 determines whether the methanol concentration falls outside the predetermined concentration range (step S2).

If the methanol concentration falls within the predetermined concentration range, the flow returns to the step S1 and the same process is repeated. If the methanol concentration has an abnormal value, outside the predetermined concentration range, the fuel cell control section 41 stands by for a fixed period of time (step S3).

When the fixed period of time has passed, the fuel cell control section 41 determines whether the methanol concentration still has an abnormal value (step S4). If the methanol concentration falls within the predetermined concentration range, the process from the step S1 is repeated. On the other hand, if the methanol concentration still has an abnormal value, the fuel cell control section 41 determines that abnormality, such as stagnation of bubbles or dust, may occur in the portion of the flow path where the concentration sensor 60 is attached, and that a restoration process to restore the state to a normal condition is required.

Even if the methanol concentration obtained by the concentration sensor 60 falls within the predetermined concentration range, if it is constant for a certain period of time, the fuel cell control section 41 determines that abnormality may occur, and that a restoration process to restore the state to a normal condition is required.

If the fuel cell control section 41 determines that a restoration process is required, it executes the restoration process (step S5). In the restoration process, the fuel cell control section 41 changes one or a combination of the number of revolutions of the liquid send-out pump 46, the aperture of the liquid send-out valve 31, and the number of revolutions of the liquid send-out pump 32, thereby changing (or pulsing) the flow of the methanol solution in the portion of the flow path to which the concentration sensor 60 is attached.

After the above restoration process, the fuel cell control section 41 determines whether the methanol concentration is restored to a normal value that falls within the predetermined concentration range (step S6). If the methanol concentration is restored to a normal condition, the process is repeated from the step S1. If it is not restored to a normal condition, the operation of the power generating section (power generating system) 40 is stopped (step S7).

As described above, according to the embodiment of the present invention, if the concentration of the fuel obtained from the detection result in the concentration sensor 60 is abnormal, one or a combination of the number of revolutions of the liquid send-out pump 46, the aperture of the liquid send-out valve and the number of revolutions of the liquid send-out pump 32 is changed, so that the flow of the methanol solution in the portion of the flow path to which the concentration sensor 60 is attached is changed (or pulsed) reliably. As a result, the bubbles or the like which stagnate in that portion can be removed effectively. Further, if the abnormal condition continues even if the restoration process is performed, the power generation section 40 is stopped. Therefore, danger can be avoided.

Moreover, the concentration sensor 60 has the following advantage. Since it is attached to the portion of the flow path at which the methanol flows against the gravity, the possibility of the bubbles being stagnating in the flow path is low. Even if the bubbles stagnate, they may easily get out above by changing the flow of the methanol solution by controlling the auxiliary mechanism 63.

Furthermore, the concentration sensor 60 is provided in the portion of the flow path at which the methanol solution flowing from the first liquid flow path to the second liquid flow path (at 60° C. or higher) is cooled to, for example, 40° C. or lower. Thus, the concentration sensor 60 is protected against an adverse influence by the heat.

Further, the concentration sensor 60 requires a very small amount of methanol solution (a negligible amount relative to all methanol solution used in the power generating section 40) to detect the concentration. That is, the amount of methanol solution flowing in the second liquid flow path is very small. Thus, the fuel supply to the DMFC stack 42 is not adversely influenced.

As has been described above, according to the present invention, the concentration of the fuel can be detected without problems.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell unit comprising:
a fuel cell;
a mixing tank, which mixes fuel with water and generates a fuel solution to be supplied to the fuel cell;
a first flow path, which flows the fuel solution between the mixing tank and the fuel cell;
a mechanism, which controls flow of the fuel solution in the first flow path;
a second flow path, which branches from the first flow path and flows the fuel solution sent out from the mixing tank back to the mixing tank;
a sensor, which detects a concentration of the fuel solution in the second flow path; and
a controller, which changes flow of the fuel solution in the second flow path by controlling the mechanism, when the concentration detected by the sensor presents a predetermined state.

2. The fuel cell unit according to claim 1, wherein:
the mechanism includes a pump; and
the controller changes the flow of the fuel solution in the second flow path by changing the number of revolutions of the pump.

3. The fuel cell unit according to claim 1, wherein:
the mechanism includes a pump; and
the controller pulses the flow of the fuel solution in the second flow path by changing the number of revolutions of the pump.

4. The fuel cell unit according to claim 1, wherein:
the mechanism includes a valve; and
the controller changes the flow of the fuel solution in the second flow path by changing an aperture of the valve.

5. The fuel cell unit according to claim 1, wherein:
the mechanism includes a valve; and
the controller pulses the flow of the fuel solution in the second flow path by changing an aperture of the valve.

6. The fuel cell unit according to claim 1, wherein the concentration sensor is attached to a portion of the second flow path at which the fuel solution flows against gravity.

7. The fuel cell unit according to claim 1, wherein the predetermined state is a state in which the concentration obtained by the sensor falls continuously outside a predetermined range or is constant for a certain period of time.

8. A fuel cell unit comprising:
a fuel cell;
a mixing tank, which mixes fuel with water and generates a fuel solution to be supplied to the fuel cell;
a sensor, which detects a concentration of the fuel solution sent out from the mixing tank;
a flow path, which flows the fuel solution between the mixing tank and the sensor;
a mechanism, which controls flow of the fuel solution in the flow path; and
a controller, which changes flow of the fuel solution in the flow path by controlling the mechanism, when the concentration detected by the sensor presents a predetermined state.

9. The fuel cell unit according to claim 8, wherein:
the mechanism includes a pump; and
the controller changes the flow of the fuel solution in the flow path by changing the number of revolutions of the pump.

10. The fuel cell unit according to claim 8, wherein:
the mechanism includes a pump; and
the controller pulses the flow of the fuel solution in the flow path by changing the number of revolutions of the pump.

11. The fuel cell unit according to claim 8, wherein:
the mechanism includes a valve; and
the controller changes the flow of the fuel solution in the second flow path by changing an aperture of the valve.

12. The fuel cell unit according to claim 8, wherein:
the mechanism includes a valve; and
the controller pulses the flow of the fuel solution in the second flow path by changing an aperture of the valve.

13. The fuel cell unit according to claim 8, wherein the concentration sensor is attached to a portion of the flow path at which the fuel solution flows against gravity.

14. The fuel cell unit according to claim 8, wherein the predetermined state is a state in which the concentration obtained by the sensor falls continuously outside a predetermined range or is constant for a certain period of time.

15. A method of controlling a fuel cell unit, the fuel cell unit comprising a fuel cell, a mixing tank which mixes fuel with water and generates a fuel solution to be supplied to the fuel cell, a sensor which senses concentration of the fuel solution sent from the mixing tank, a mechanism which controls flow of the fuel solution sent from the mixing tank, the method comprising:
sensing the fuel solution by the sensor; and
changing the flow of the fuel solution by the mechanism, when the concentration of the fuel cell sensed by the sensor presents a predetermined state.

16. The method according to claim 15, wherein the mechanism is a pump, and
wherein the changing changes the flow of the fuel solution by changing the number of the revolution of the pump.

17. The method according to claim 15, wherein the mechanism is a valve, and
wherein the changing changes the flow of the fuel solution by changing an aperture of the valve.

18. The method according to claim 15, wherein the predetermined state is a state in which the concentration obtained by the sensor falls continuously outside a predetermined range or is constant for a certain period of time.
